(19) United States
(12) Patent Application Publication
(10) Pub. No.: US 2015/0364122 A1
(43) Pub. Date: Dec. 17, 2015

(54) Music Note Indicating Method And System For Electronic Piano, Mobile Terminal And Electronic Piano

(71) Applicant: Bin Ye, Beijing (CN)

(72) Inventor: Bin Ye, Beijing (CN)

(21) Appl. No.: 14/729,305

(22) Filed: Jun. 3, 2015

(30) Foreign Application Priority Data
Jun. 13, 2014 (CN) 201410265765.8
Jun. 13, 2014 (CN) 201420317977.1

(51) Int. Cl. G10H 1/00; G10C 5/00

(52) U.S. Cl. CPC G10H 1/0016; G10C 5/00

(57) ABSTRACT

Provided is a music note indicating method for an electronic piano, a mobile terminal, an electronic piano and a music note indicating system. The electronic piano includes a keyboard with a plurality of keys, a controlling device and a plurality of LED indicating lamps. The plurality of LED indicating lamps are located in a plane parallel to the keyboard. The method includes: obtaining a music score information of a predetermined music score by a mobile terminal; analyzing the music score information to generate a music note sequence comprising at least one first music note data by the mobile terminal; generating a control signal according to the at least one first music note data and sending the control signal to the controlling device by the mobile terminal; and controlling the plurality of LED indicating lamps to indicate the music note sequence according to the control signal by the controlling device.

### CROSS-REFERENCE TO RELATED APPLICATIONS

The present application claims priority from Chinese Patent Applications Nos. 201410265765.8 and 201420317977.1, both filed with the State Intellectual Property Office of P. R. China on Jun. 13, 2014, all of which are hereby incorporated herein by reference.

### BACKGROUND OF THE INVENTION

The present disclosure relates to an electronic music synthesis field, and more particularly to a music note indicating method for an electronic piano, a mobile terminal, an electronic piano, and a music note indicating system for an electronic piano.

As a kind of electroacoustic instrument, electronic pianos which started in the sixties or seventies and became popular in the eighties to the nineties of the 20th century are used in some occasions instead of a piano. In a conventional electronic piano, the keyboard is used as an on-off switch. Once the keys are pressed, internal crystal oscillators will begin to work, which may generate a waveform having a certain frequency, and then the waveform is amplified through a frequency divider and sent to a loud speaker to generate a sound.

Generally, the electronic piano is provided with a voice control program, a rhythm control program, accompaniment option control program and so on. A music note option system of an existing electronic piano is arranged on a main keyboard panel of the electronic piano, and each music note corresponds to one key. When the user presses a key, the electronic piano may refer to a music note library in the program and control to output a corresponding music note according to the user's choice, thus playing a required music.

At present, in the related art, the electronic piano is only capable of displaying a music score on a screen, but there are no visual indication displayed on the keyboard to indicate music notes. Therefore, it is difficult for beginners who are no familiar with the music score to do self-study, and it is also difficult for the beginners to play the piano independently.

### BRIEF SUMMARY OF THE INVENTION

Embodiments of the present disclosure seek to solve at least one of the problems existing in the related art to at least some extent.

Accordingly, a first objective of the present disclosure is to provide a music note indicating method for an electronic piano. With the music note indicating method for an electronic piano according to embodiments of the present disclosure, it is convenient for beginners who are not familiar with the music score may to learn to play the piano, the difficulty for studying to play piano on one's own may be reduced, and aims of learning to play piano and being familiar with music score quickly may be achieved.

A second objective of the present disclosure is to provide a mobile terminal.

A third objective of the present disclosure is to provide an electronic piano.

A fourth objective of the present disclosure is to provide a music note indicating system for an electronic piano.

According to a first aspect of embodiments of the present disclosure, a music note indicating method for an electronic piano is provided. The electronic piano includes a keyboard with a plurality of keys, a controlling device and a plurality of LED indicating lamps corresponding to the plurality of keys respectively, and the plurality of LED indicating lamps are located in a plane parallel to the keyboard. The music note indicating method for an electronic piano includes steps of: obtaining a music score information of a predetermined music score by a mobile terminal; analyzing the music score information to generate a music note sequence comprising at least one first music note data by the mobile terminal; generating a control signal according to the at least one first music note data and sending the control signal to the controlling device by the mobile terminal; and controlling the plurality of LED indicating lamps to indicate the music note sequence according to the control signal by the controlling device.

With the music note indicating method for the electronic piano according to embodiments of the present disclosure, the music score information of the predetermined music score may be analyzed to generate the music note sequence including at least one first music note data by the mobile terminal, the control signal may be generated according to the at least one first music note data and be sent to the controlling device by the mobile terminal, and the plurality of LED indicating lamps may be controlled to indicate the music note sequence by the controlling device according to the control signal. The music note indicating method for the electronic piano may facilitate a person who is not familiar with the music score to learn to play the electronic piano, greatly reduce the difficulty for playing piano on one's own, and achieve the aims of learning to play piano quickly and being familiar with music score.

According to a second aspect of embodiments of the present disclosure, a mobile terminal is provided. The mobile terminal includes: a first obtaining module, configured to obtain a music score information of a predetermined music score; a first generating module, configured to analyze the music score information to generate a music note sequence comprising at least one first music note data; a second generating module, configured to generate a control signal according to the at least one first music note data; and a sending module, configured to send the control signal to an electronic piano comprising a plurality of LED indicating lamps, such that the plurality of LED indicating lamps are controlled to indicate the music note sequence according to the control signal.

With the mobile terminal according to embodiments of the present disclosure, the music score information of the predetermined music score may be analyzed to generate the music note sequence including at least one first music note data by the mobile terminal, the control signal may be generated according to the at least one first music note data and be sent to the controlling device by the mobile terminal, and the plurality of LED indicating lamps may be controlled to indicate the music note sequence by the controlling device according to the control signal. The music note indicating method for the electronic piano may facilitate a person who is not familiar with the music score to learn to play the electronic piano, greatly reduce the difficulty for playing piano on one's own, and achieve the aims of learning to play piano quickly and being familiar with music score.

According to a third aspect of embodiments of the present disclosure, an electronic piano is provided. The electronic piano includes: a keyboard with a plurality of keys; a plurality of LED indicating lamps corresponding to the plurality of keys respectively and located in a plane parallel to the keyboard; and a controlling device, configured to receive a control signal from a mobile terminal according to embodiments of the second aspect of the present disclosure, and to control the plurality of LED indicating lamps to indicate the music note sequence according to the control signal.

With the electronic piano according to an embodiment of the present disclosure, the control signal sent by the mobile terminal may be received by the controlling device, and the plurality of LED indicating lamps may be controlled to indicate the music note sequence by the controlling device according to the control signal, i.e. a next music note to be played may be indicated by a corresponding LED indicating lamp. If the current music note is played correctly on the electronic piano, the next music note may be indicated subsequently by a corresponding LED indicating lamp. If the current music note is incorrectly played on the electronic piano, the next music note to be played may not be indicated by the plurality of LED indicating lamps. The electronic piano may facilitate a person who is not familiar with the music score to learn to play electronic piano, greatly reduce the difficulty for playing piano on one's own, and achieve the aims of learning to play piano quickly and being familiar with music score.

According to a fourth aspect of the present disclosure, a music note indicating system for an electronic piano is provided. The music note indicating system for an electronic piano includes: a mobile terminal according to the second aspect of embodiments of the present disclosure, and an electronic piano according to embodiments of the third aspect of the present disclosure.

With the electronic piano note prompting system according to an embodiment of the present disclosure, the music score information of the predetermined music score may be analyzed to generate the music note sequence including at least one first music note data by the mobile terminal, the control signal may be generated according to the at least one first music note data and be sent to the controlling device by the mobile terminal, and the plurality of LED indicating lamps may be controlled to indicate the music note sequence by the controlling device according to the control signal. The music note indicating method for the electronic piano may facilitate a person who is not familiar with the music score to learn to play the electronic piano, greatly reduce the difficulty for playing piano on one's own, and achieve the aims of learning to play piano quickly and being familiar with music score.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is a flow chart of a music note indicating method for an electronic piano according to an embodiment of the present disclosure;

FIG. 2 is a flow chart of a music note indicating method for an electronic piano according to another embodiment of the present disclosure;

FIG. 3 is a schematic diagram of a mobile terminal according to an embodiment of the present disclosure;

FIG. 4 is a schematic diagram of an electronic piano according to an embodiment of the present disclosure;

FIG. 5 is a schematic diagram of a music note indicating system for an electronic piano according to an embodiment of the present disclosure;

FIG. 6(a) is a top view showing a position relationship between a plurality of LED indicating lamps and the plurality of keys of an electronic piano according to an embodiment of the present disclosure; and

FIG. 6(b) is a side view showing a position relationship between a plurality of LED indicating lamps and the plurality of keys of an electronic piano according to an embodiment of the present disclosure.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

In the following, a music note indicating method for an electronic piano, a mobile terminal, an electronic piano, and a music note indicating system for an electronic piano according to embodiments of the present disclosure will be described in detail with reference to the drawings.

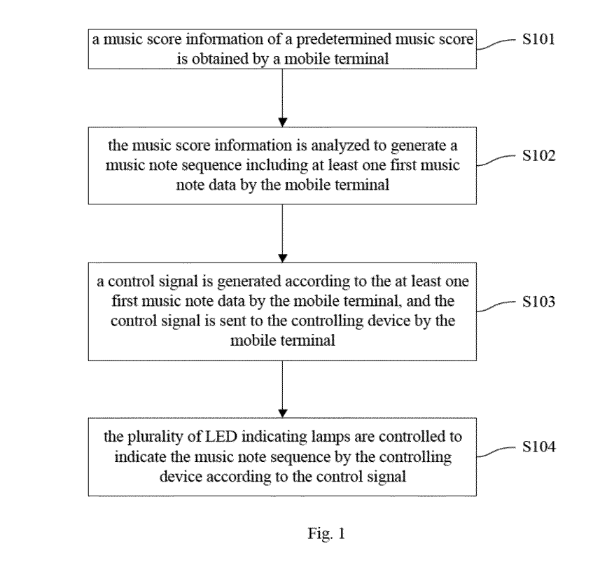

FIG. 1 is a flow chart of a music note indicating method for an electronic piano according to an embodiment of the present disclosure.

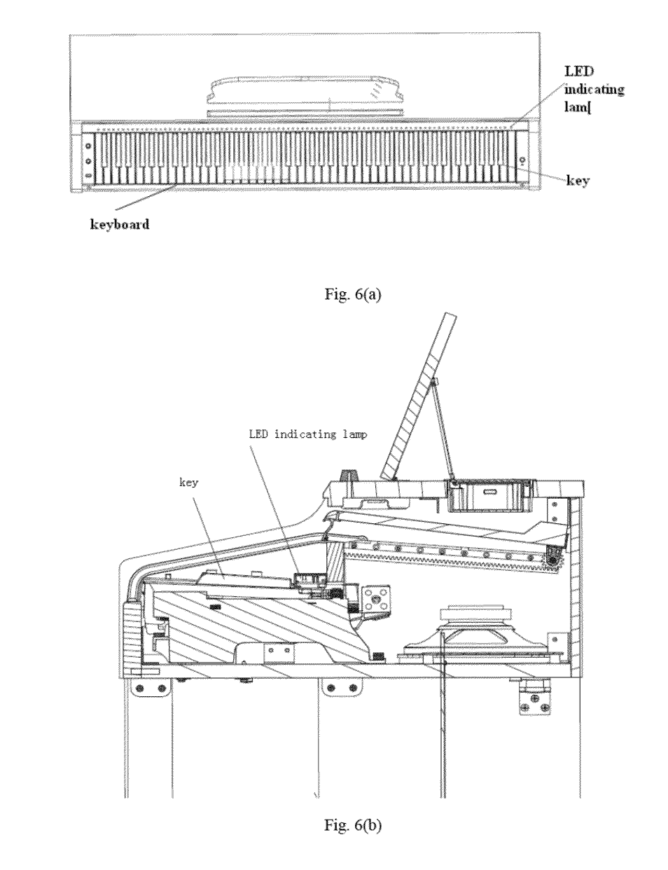

It should be noted that, in some embodiments of the present disclosure, the electronic piano includes a keyboard with a plurality of keys, a controlling device and a plurality of LED indicating lamps corresponding to the plurality of keys respectively. The plurality of LED indicating lamps are located in a plane parallel to the keyboard, i.e. the plane of the plurality of keys. As shown in FIG. 6(a) and FIG. 6(b), FIG. 6(a) is a top view showing a position relation between the plurality of LED indicating lamps and the plurality of keys of the electronic piano, FIG. 6(b) is a side view showing a position relation between the plurality of LED indicating lamps and the plurality of keys of the electronic piano. In some embodiments, each of the plurality of keys may be corresponding to one or more LED indicating lamps.

As shown in FIG. 1, the music note indicating method for an electronic piano according to embodiments of the present disclosure may include the following steps S101-104.

In the step S101, a music score information of a predetermined music score is obtained by a mobile terminal.

In some embodiments of the present disclosure, the mobile terminal may include hardware devices with various operating systems, such as a tablet computer, a mobile phone, and so on.

In some embodiments, the predetermined music score may be pre-stored in the mobile terminal. In some embodiments, the predetermined music score may be downloaded from a network database or a cloud server.

In the step S102, the music score information is analyzed to generate a music note sequence including at least one first music note data by the mobile terminal.

In some embodiments of the present disclosure, the first music note data may be a musical instrument digital interface (MIDI).

Specifically, in some embodiments of the present disclosure, the mobile terminal may analyze the music score information to generate a MIDI music note sequence and a corresponding relation between music notes and music score.

In the step S103, a control signal is generated according to the at least one first music note data by the mobile terminal, and the control signal is sent to the controlling device by the mobile terminal.

In some embodiments, the plurality of LED indicating lamps is in one-to-one correspondence to the plurality of keys. In other words, each LED indicating lamp is corresponding to one corresponding key.

In the step S104, the plurality of LED indicating lamps are controlled to indicate the music note sequence according to the control signal by the controlling device.

Specifically, in some embodiments of the present disclosure, the first music note data in the music note sequence may be obtained in turn by the mobile terminal. Then the control signal may be generated according to the first music note data, and be sent to the controlling device by the mobile terminal. Subsequently, the plurality of LED indicating lamps is controlled to indicate the music note sequence according to the control signal by the controlling device. In this way, a player may play piano according to the indications. In some embodiments of the present disclosure, the mobile terminal transmits the control signal to the controlling device via wire communication (such as a MIDI connection line). In some embodiments of the present disclosure, the mobile terminal transmits the control signal to the controlling device via wireless communication, e.g., wireless fidelity (Wi-Fi).

It should be noted that, in some embodiments of the present disclosure, the MIDI music note sequence may be sent directly to the controlling device, such that the controlling device controls to output sounds of the corresponding music notes MIDI music note sequence. The control signal may be generated according to the MIDI music note sequence, and be sent to the controlling device by the mobile terminal. The LED indicating lamps may be controlled to turn on or turn off according to the control signal by the controlling device.

With the music note indicating method for the electronic piano according to embodiments of the present disclosure, the music score information of the predetermined music score may be analyzed to generate the music note sequence including at least one first music note data by the mobile terminal, the control signal may be generated according to the at least one first music note data and be sent to the controlling device by the mobile terminal, and the plurality of LED indicating lamps may be controlled to indicate the music note sequence by the controlling device according to the control signal. The music note indicating method for the electronic piano may facilitate a person who is not familiar with the music score to learn to play the electronic piano, greatly reduce the difficulty for playing piano on one's own, and achieve the aims of learning to play piano quickly and being familiar with music score.

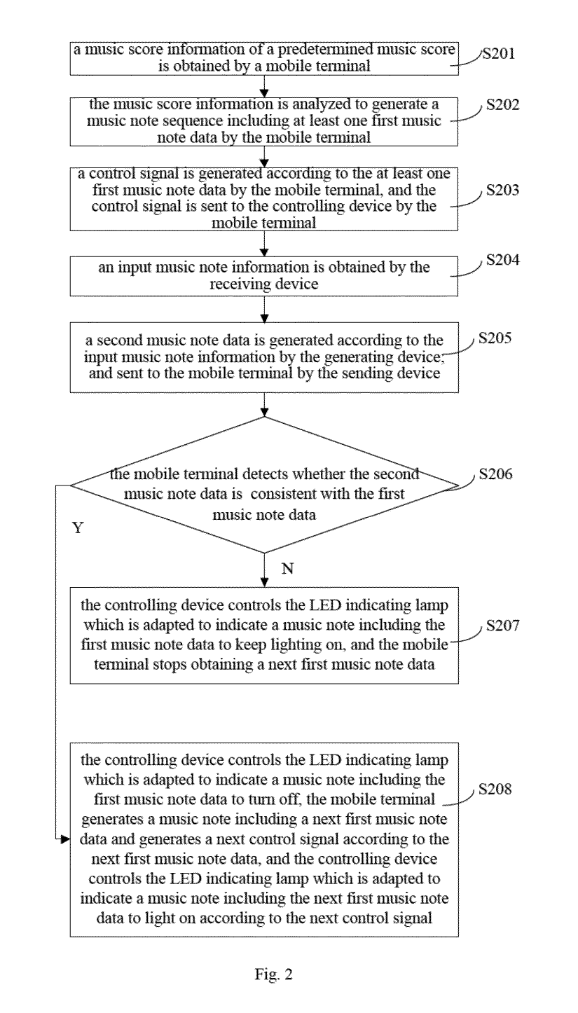

FIG. 2 is a flow chart of a music note indicating method for an electronic piano according to another embodiment of the present disclosure.

In some embodiments of the present disclosure, a second music note data may be obtained and sent to mobile terminal, and the mobile terminal detects whether the second music note data is consistent with the first music note data. Specifically, as shown in FIG. 1, the music note indicating method for an electronic piano according to embodiments of the present disclosure may include the following steps S201-207. Then the interaction between the player and the electronic piano may be improved, and it is more convenient for beginners to play piano on their own.

In the step S201, a music score information of a predetermined music score is obtained by a mobile terminal.

In some embodiments of the present disclosure, the mobile terminal may include hardware devices with various operating systems, such as a tablet computer, a mobile phone, and so on.

In some embodiments, the predetermined music score may be pre-stored in the mobile terminal. In some embodiments, the predetermined music score may be downloaded from a network database or a cloud server.

In the step S202, the music score information is analyzed to generate a music note sequence including at least one first music note data by the mobile terminal.

In some embodiments of the present disclosure, the first music note data may be a MIDI.

Specifically, in some embodiments of the present disclosure, the mobile terminal may analyze the music score information to generate a MIDI music note sequence and a corresponding relation between music notes and music score.

In the step S203, a control signal is generated according to the at least one first music note data by the mobile terminal, and the control signal is sent to the controlling device by the mobile terminal.

In some embodiments, the plurality of LED indicating lamps is in one-to-one correspondence to the plurality of keys. In other words, each LED indicating lamp is corresponding to one corresponding key.

Specifically, in some embodiments of the present disclosure, the first music note data in the music note sequence may be obtained in turn by the mobile terminal. Then the control signal may be generated according to the first music note data, and be sent to the controlling device by the mobile terminal. In some embodiments of the present disclosure, the mobile terminal transmits the control signal to the controlling device via wire communication (such as a MIDI connection line). In some embodiments of the present disclosure, the mobile terminal transmits the control signal to the controlling device via wireless communication, e.g., wireless fidelity (Wi-Fi).

In some embodiments, the method includes a step of obtaining a second music note data by the mobile terminal. Specifically, obtaining a second music note data by the mobile terminal includes the following steps S204-S205.

In some embodiments of the present disclosure, the electronic piano may further include a receiving device, a generating device and a sending device.

In the step S204, an input music note information is obtained by the receiving device.

In some embodiments, after the control signal is sent to the controlling device by the mobile terminal, the mobile terminal or the controlling device may remind the player to start playing, so that the input music note information corresponding to the pressed key may be received.

In the step S205, a second music note data is generated according to the input music note information by the generating device; and sent to the mobile terminal by the sending device.

In some embodiments, the input music note information is converted into the second music note data, and sent to the mobile terminal. In some embodiments, the second music note data may be a MIDI.

In the step S206, the mobile terminal detects whether the second music note data is consistent with the first music note data.

In the step S207, if it is determined the second music note data is inconsistent with the first music note data, the controlling device controls the LED indicating lamp which is adapted to indicate a music note comprising the first music note data to keep lighting on, and the mobile terminal stops obtaining a next first music note data.

In the step S208, if it is determined the second music note data is consistent with the first music note data, the controlling device controls the LED indicating lamp which is adapted to indicate a music note comprising the first music note data to turn off, the mobile terminal generates a music note comprising a next first music note data and generates a next control signal according to the next first music note data, and the controlling device controls the LED indicating lamp which is adapted to indicate a music note comprising the next first music note data to light on according to the next control signal.

That is to say, a next music note to be played may be indicated by a corresponding LED indicating lamp. If the current music note is played correctly on the electronic piano, the next music note may be indicated subsequently by a corresponding LED indicating lamp, i.e., the LED lamp corresponding to the next music note may turn on. If the current music note is incorrectly played on the electronic piano, the next music note to be played may not be indicated by the plurality of LED indicating lamps, and the LED lamp corresponding to the current music note may keep turning on and the LED lamp corresponding to the next music note may not turn on. It may facilitate a person who is not familiar with the music score to learn to play electronic piano.

It should be noted that, in some embodiments of the present disclosure, the MIDI music note sequence may be sent directly to the controlling device, such that the controlling device controls to output sounds of the corresponding music notes according to the MIDI music note sequence. The control signal may be generated according to the MIDI music note sequence, and be sent to the controlling device by the mobile terminal. The LED indicating lamps may be controlled to turn on or turn off according to the control signal by the controlling device.

With the music note indicating method for the electronic piano according to embodiments of the present disclosure, the input music note information may be obtained by the receiving device, the second music note data may be generated by the generating device according to the input music note information, the second music note data may be sent to the mobile terminal by the sending device, the mobile terminal detects whether the second music note data is consistent with the first music note data, and following operations may be made accordingly, i.e., the next music notes to be played may be indicated by the plurality of LED indicating lamps. If the current music note is played correctly on the electronic piano, the next music note may be indicated subsequently by a corresponding LED indicating lamp. If the current music note is incorrectly played on the electronic piano, the next music note to be played may not be indicated by the plurality of LED indicating lamps. With the music note indicating method for the electronic piano according to embodiments of the present disclosure, the interaction between the player and the electronic piano may be improved, it is convenient for a beginner to learn to play piano, and the user experience may be enhanced.

In some embodiments of the present disclosure, when the music score information may be a video file including a control script, the music note indicating method for an electronic piano may further include: the control script of the video file is obtained, and the video file is controlled by the mobile terminal according to the second music note data and the control script. For example, when the music score information is a video file with a control script, the video will be suspended by the mobile terminal according to the control script. And a next action is determined by an input determination of a player, which includes replay, continuing to play, waiting, etc. Therefore, better interaction between the player and the electronic piano may be achieved via the control script, a performance better than traditional video teaching may be obtained, and the user experience may be enhanced.

In some embodiments of the present disclosure, the music note indicating method for an electronic piano may further include: a music played on the electronic piano is recorded by the mobile terminal. It should be understood that, in some embodiments of the present disclosure, the music information may include pitch, strength for pressing the key, and the time for pressing the key, etc. Specifically, the mobile terminal may receive and record the music information (such as pitch, strength for pressing the key, and the time for pressing the key), and save the recorded music information as a MIDI file. In some embodiments, the MIDI file may be sent to the electronic piano to playback. In some embodiments, the MIDI file may be uploaded to a cloud for sharing. Therefore, the user experience may be further improved.

In some embodiments of the present disclosure, the music note indicating method for an electronic piano may further include the following steps. Information of the music is obtained, and the information of the music is evaluated according to the predetermined music score. Specifically, the mobile terminal may obtain the music information (such as pitch, strength for pressing the key, and the time for pressing the key), and evaluate the music information according to the predetermined music score to obtain an evaluation result. In some embodiments, the evaluation result includes at least one of a score, an advantage, a shortcoming, and a suggestion. Therefore, the player may see their shortcomings and modify according to the suggestion, thus enhancing their playing skills.

It should be noted that, in some embodiments of the present disclosure, the mobile terminal may set parameters for the electronic piano. For example, the mobile terminal may package the functions of adjusting the parameters of the electronic piano in a system exclusive message (SEM) data regulated by the MIDI, and then send the control data to the electronic piano through the SEM data to change the set parameters of the electronic piano. It should be understood that, the information of the set parameters may be obtained via the SEM data. Therefore, the mobile terminal may change the set parameters of the electronic piano to make the operations more convenient.

Further, embodiments of the present disclosure embodiment also provide a mobile terminal.

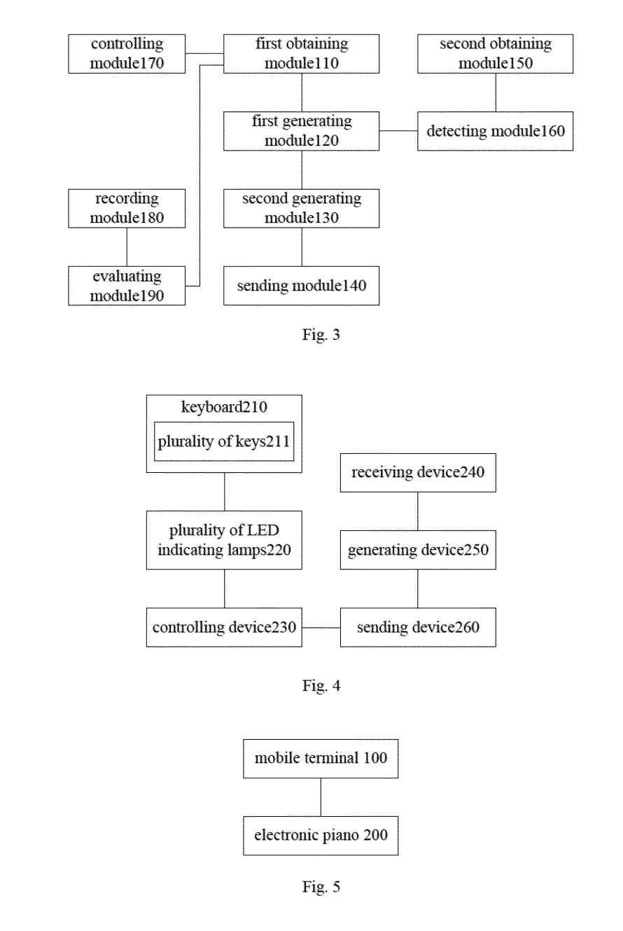

FIG. 3 is a schematic diagram of a mobile terminal according to an embodiment of the present disclosure.

It should be noted that, in some embodiments of the present disclosure, the mobile terminal may include hardware devices with various operating systems, such as a tablet computer, a mobile phone, and so on.

As shown in FIG. 3, the mobile terminal includes a first obtaining module 110, a first generating module 120, a second generating module 130, and a sending module 140.

Specifically, in some embodiments, the first obtaining module 110 is configured to obtain a music score information of a predetermined music score. In one embodiment of the present disclosure, the predetermined music score may be pre-stored in the mobile terminal. In some embodiments, the predetermined music score may be downloaded from a network database or a cloud server.

In some embodiments, the first generating module 120 is configured to analyze the music score information to generate a music note sequence including at least one first music note data. In one embodiment of the present disclosure, the first music note data may be a MIDI. Specifically, the first generating module 120 is configured to analyze the music score information to generate a MIDI music note sequence and the corresponding relation between music notes and music score.

In some embodiments, the second generating module 130 is configured to generate a control signal according to the at least one first music note data. Specifically, in one embodiment of the present disclosure, the second generating module 130 is configured to obtain the first music note data in the music note in turn, and generate a corresponding control signal according to the first music note data.

The sending module 140 is configured to send the control signal to an electronic piano including a plurality of LED indicating lamps, such that the plurality of LED indicating lamps are controlled to indicate the music note sequence according to the control signal. In some embodiments of the present disclosure, the sending module 140 transmits the control signal to the controlling device of the electronic piano via wire communication (such as a MIDI connection line). In some embodiments of the present disclosure, the mobile terminal transmits the control signal to the controlling device of the electronic piano via wireless communication, e.g., wireless fidelity (Wi-Fi).

In some embodiments, the plurality of LED indicating lamps is in one-to-one correspondence to the plurality of keys of the electronic piano. In other words, each LED indicating lamp is corresponding to one corresponding key.

It should be noted that, in some embodiments of the present disclosure, the MIDI music note sequence may be sent directly to the controlling device of the electronic piano, such that the controlling device controls to output sounds of the corresponding music notes according to the MIDI music note sequence. The control signal may be generated according to the MIDI music note sequence, and be sent to the controlling device by the mobile terminal. The LED indicating lamps may be controlled to turn on or turn off according to the control signal by the controlling device.

Further, in one embodiment of the present disclosure, as shown in FIG. 3, the mobile terminal further includes a second obtaining module 150 and a detecting module 160.

Specifically, the second obtaining module 150 is configured to obtain a second music note data. Specifically, in some embodiments of the present disclosure, the electronic piano may obtain an input music note information, and generate the second music note data according to the input music note information. The second obtaining module 150 may obtain the second music note data sent by the electronic piano.

The detecting module 160 is configured to detect whether the second music note data is consistent with the first music note data. If the detecting module 160 determines that the second music note data is inconsistent with the first music note data, the first obtaining module 110 is configured to stop obtaining a next first music note data. If the detecting module 160 determines that the second music note data is consistent with the first music note data, the first generating module 120 is configured to generate a music note comprising a next first music data, and the second generating module 130 is configured to generate a next control signal according to the next first music note data.

For example, after the control signal is sent to the electronic piano by the sending module 140, the mobile terminal or the electronic piano may remind the player to start playing, so that the electronic piano may receive the input music note information corresponding to the pressed key, and a second music note data may be generated and sent to the mobile terminal. The detecting module 160 may detect whether the second music note data is consistent with the first music note data. If it is determined the second music note data is inconsistent with the first music note data, the first obtaining module 110 may stop obtaining a next first music note data. If it is determined the second music note data is consistent with the first music note data, the first generating module 120 may generate a music note comprising a next first music data, and the second generating module 130 may generate a next control signal according to the next first music note data.

In other words, the music note to be played may be indicated by the plurality of LED indicating lamps. If the current music note is played correctly on the piano, a next music note may be indicated by a corresponding LED indicating lamp, i.e., the LED indicating lamp corresponding to the next music note data may be turned on. If the current music not is played incorrectly on the piano, the next music note to be played may not be indicated by a corresponding LED indicating lamp, i.e., the LED indicating lamp corresponding to the current music note may keep turning on. Therefore, it is convenient for a player who is not familiar with the music score to pay the electronic piano.

Optionally, in one embodiment of the present disclosure, as shown in FIG. 3, the mobile terminal further includes a controlling module 170. The controlling module 170 is configured to obtain a control script of a video file and control the video file according to the second music note data and the control script. For example, when the music score information is a video file with a control script, the controlling module 170 may suspend the video according to the control script, and to determine a next action according to an input of the player, the next action includes at least one of replaying, continuing to play, waiting, and so on. Therefore, more interaction may be achieved via the control script, performance better than a traditional video teaching may be obtained, and the user experience may be enhanced.

Optionally, in one embodiment of the present disclosure, as shown in FIG. 3, the mobile terminal further includes a recording module 180. The recording module 180 is configured to record a music played on the electronic piano. It should be understood that, in some embodiments of the present disclosure, the music may include the music information, such as pitch, strength for pressing the key, and the time for pressing the key. Specifically, the recording module 180 may receive and record the music information (such as pitch, strength for pressing the key, and the time for pressing the key), and save the music information as a MIDI file. In some embodiments, the MIDI file may be sent to the electronic piano to playback. In some embodiments, the MIDI file may also be uploaded to a cloud for sharing. Therefore, the user experience may be further enhanced.

Optionally, in one embodiment of the present disclosure, as shown in FIG. 3, the mobile terminal further includes an evaluating module 190. The evaluating module 190 is configured to obtain information of the music and evaluate the information of the music according to the predetermined music score. Specifically, the evaluating module 190 is configured to obtain the music information, such as pitch, strength for pressing the key, and the time for pressing the key, and evaluate the music information according to the predetermined music score to obtain an evaluation result. In some embodiments, the evaluation result includes at least one of a score, an advantage, a shortcoming, and a suggestion. Therefore, the player may see their shortcomings and modify according to the suggestion, thus enhancing their playing skills.

With the mobile terminal according to embodiments of the present disclosure, the music score information of the predetermined music score may be analyzed to generate the music note sequence including at least one first music note data by the first generating module, the control signal may be generated according to the at least one first music note data by the second generating module and sent to the controlling device by the sending device, and the plurality of LED indicating lamps may be controlled to indicate the music note sequence by the controlling device according to the control signal. The mobile terminal according to embodiments of the present disclosure may facilitate a person who is not familiar with the music score to learn to play the electronic piano, greatly reduce the difficulty for playing piano on one's own, and achieve the aims of learning to play piano quickly and being familiar with music score.

It should be noted that, in some embodiments of the present disclosure, the mobile terminal may be configured to set parameters of the electronic piano. For example, the mobile terminal may package the function of adjusting the parameters of the electronic piano in a SEM data regulated by a MIDI, and then send the control data to the electronic piano through the SEM data, i.e., the sett parameters of the electronic piano may be changed. It should be understood that, the SEM may obtain the set parameters of the electronic piano. Therefore, the mobile terminal may change the set parameters of the electronic piano to make the operation more convenient.

Further, embodiments of the present disclosure embodiment also provide an electronic piano.

FIG. 4 is a schematic diagram of an electronic piano according to an embodiment of the present disclosure.

As shown in FIG. 4, the electronic piano includes a keyboard 210 with a plurality of keys 211, a plurality of LED indicating lamps 220 and a controlling device 230. It should be noted that, in some embodiments of the present disclosure, the electronic piano includes a plurality of LED indicating lamps 220 corresponding to the plurality of keys 211 respectively, and the plurality of LED indicating lamps 220 are located in a plane parallel to the keyboard 210. As shown in FIG. 6(a) and FIG. 6(b), FIG. 6(a) is a top view showing the position relation between the plurality of LED indicating lamps and the plurality of keys, and FIG. 6(b) is an offside view of the position relation between the plurality of LED indicating lamps and the plurality of keys. In some embodiments, one key may be corresponding to one or more the LED indicating lamps.

Specifically, in some embodiments, the controlling device 230 is configured to receive a control signal from a mobile terminal according to any above embodiments, and to control the plurality of LED indicating lamps 220 to indicate the music note sequence according to the control signal. More specifically, the mobile terminal may analyze the music score information of a predetermined music score to generate the music note sequence including at least one first music note data, then the control signal may be generated according to the first music note data and be sent to the electronic piano, so that the controlling device 230 may receive the control signal from the mobile terminal. In some embodiments of the present disclosure, the first music note data may be the MIDI.

Further, in some embodiments of the present disclosure, as shown in FIG. 4, the electronic piano further includes a receiving device 240, a generating device 250, and a sending device 260.

Specifically, in some embodiments, the receiving device 240 is configured to receive an input music note information. For example, after the control signal is sent to the electronic piano by the mobile terminal, the mobile terminal or the electronic piano may remind the player to start to play the piano, so that the receiving device 240 is configured to receive the input music note information corresponding to the pressed key.

The generating device 250 is configured to generate a second music note data according to the input music note information. The sending device 260 is configured to send the second music note data to the mobile terminal. In some embodiments, the second note data may be the MIDI.

More specifically, the generating device 250 is configured to generate the second music note data, and the second music note data may be sent to the mobile terminal, so that the mobile terminal detects whether the second music note data is consistent with the first music note data.

In some embodiments, when the mobile terminal determines the second music note data is inconsistent with the first music note data, the controlling device 230 is further configured to control the LED indicating lamp 220 which is adapted to indicate a music note comprising the first music note data to keep lighting on; and when the mobile terminal determines the second music note data is consistent with the first music note data, the controlling device 230 is further configured to control the LED indicating lamp 220 which is adapted to indicate a music note comprising the first music note data to turn off, and to control the LED indicating lamp 220 which is adapted to indicate a music note comprising a next first music note data to light on.

That is to say, a next music note to be played may be indicated by a corresponding LED indicating lamp. If the current music note is played correctly on the electronic piano, the next music note may be indicated subsequently by a corresponding LED indicating lamp, i.e., the LED lamp corresponding to the next music note may turn on. If the current music note is incorrectly played on the electronic piano, the next music note to be played may not be indicated by the plurality of LED indicating lamps, and the LED lamp corresponding to the current music note may keep turning on and the LED lamp corresponding to the next music note may not turn on. It may facilitate a person who is not familiar with the music score to learn to play electronic piano.

With the electronic piano according to embodiments of the present disclosure, the control signal from the mobile terminal according to embodiments of the second aspect of the present disclosure may be received by the controlling device, and the plurality of LED indicating lamps may be controlled to indicate the music note sequence by the controlling device according to the control signal. If the music note is played correctly on the piano, a next music note may be indicated with a corresponding LED indicating lamp. If the music note is played incorrectly on the piano, a next music note may not be indicated by the corresponding LED indicating lamp. The mobile terminal according to embodiments of the present disclosure may facilitate a person who is not familiar with the music score to learn to play the electronic piano, greatly reduce the difficulty for playing piano on one's own, and achieve the aims of learning to play piano quickly and being familiar with music score.

It should be noted that, in some embodiments of the present disclosure, the MIDI music note sequence may be sent directly to the electronic piano, such that the electronic piano provides sounds of the corresponding music notes according to the MIDI music note sequence. The control signal may be generated according to the MIDI music note sequence, and be sent to the electronic piano by the mobile terminal. The LED indicating lamps may be controlled to turn on or turn off by the electronic piano according to the control signal.

Further, embodiments of the present disclosure embodiment also provide a music note indicating system for an electronic piano.

FIG. 5 is a schematic diagram of a music note indicating system for an electronic piano according to an embodiment of the present disclosure.

As shown in FIG. 5, the music note indicating system for an electronic piano includes a mobile terminal 100 and an electronic piano 200.

Specifically, in some embodiments, the description of the mobile terminal 100 may refer to the detailed description described above, thus detailed description thereof may be omitted herein.

The description of the electronic piano 200 may refer to the detailed description described above, thus detailed description thereof may be omitted herein.

With the music note indicating system for the electronic piano according to an embodiment of the present disclosure, the music score information of the predetermined music score may be analyzed to generate the music note sequence including at least one first music note data by the mobile terminal, the control signal may be generated according to the at least one first music note data and be sent to the controlling device by the mobile terminal, and the plurality of LED indicating lamps may be controlled to indicate the music note sequence by the controlling device according to the control signal. The music note indicating system for an electronic piano may facilitate a person who is not familiar with the music score to learn to play the electronic piano, greatly reduce the difficulty for playing piano on one's own, and achieve the aims of learning to play piano quickly and being familiar with music score.

In the description of the present disclosure, it should be noted that, the terms “center”, “vertical”, “horizontal”, “length”, “width”, “thickness”, “up”, “lower”, “before” and “after”, “left”, “right”, “vertical”, “horizontal”, “top”, “bottom” “in”, “outside”, “clockwise”, “clockwise”, “axial”, “radical”, “peripheral” indicates the location or position as shown in the figure of relationship based on location or position, only to facilitate the description of the present disclosure and simplify the description, device or component rather than indicate or suggest that must have a specific range, the range of structure and operation of specific, and therefore cannot be interpreted as limiting the present disclosure.

In addition, terms such as “first” and “second” are used herein for purposes of description and are not intended to indicate or imply relative importance or significance. Therefore, defining a “first”, “second” features may be explicitly or implicitly includes at least one of the characteristics of. in the description of the present disclosure, “a plurality of” means two or more than two features, unless specified otherwise.

In the description of the present disclosure, unless specified otherwise and defining, the first character in the second character “on” or “down” may be direct contact with the first and second characteristics, or the indirect contact with the first and second characteristic through intermediaries. Moreover, the first character in the second character “on”, “top” and “above” may be the upper part or above the diagonal, or simply represent the first level height greater than the second characters. The first character in the second character “down”, “below” and “under” may be directly or inclined below, or simply represent the first level height less than the second characters.

Any process or method described in the flowing diagram or other means may be understood as a module, segment or portion including one or more executable instruction codes of the procedures configured to achieve a certain logic function or process, and the preferred embodiments of the present disclosure include other performances, in which the performance may be achieved in other orders instead of the order shown or discussed, such as in a almost simultaneous way or in an opposite order, which should be appreciated by those having ordinary skills in the art to which embodiments of the present disclosure belong.

The logic and/or procedures indicated in the flowing diagram or described in other means herein, such as a constant sequence table of the executable code for performing a logical function, may be implemented in any computer readable storage medium so as to be adopted by the code execution system, the device or the equipment (such a system based on the computer, a system including a processor or other systems fetching codes from the code execution system, the device and the equipment, and executing the codes) or to be combined with the code execution system, the device or the equipment to be used. With respect to the description of the present invention, “the computer readable storage medium” may include any device including, storing, communicating, propagating or transmitting program so as to be used by the code execution system, the device and the equipment or to be combined with the code execution system, the device or the equipment to be used. The computer readable medium includes specific examples (a non-exhaustive list): the connecting portion (electronic device) having one or more arrangements of wire, the portable computer disc cartridge (a magnetic device), the random access memory (RAM), the read only memory (ROM), the electrically programmable read only memory (EPROMM or the flash memory), the optical fiber device and the compact disk read only memory (CDROM). In addition, the computer readable storage medium even may be papers or other proper medium printed with program, as the papers or the proper medium may be optically scanned, then edited, interpreted or treated in other ways if necessary to obtain the program electronically which may be stored in the computer memory.

It should be understood that, each part of the present invention may be implemented by the hardware, software, firmware or the combination thereof. In the above embodiments of the present invention, the plurality of procedures or methods maybe implemented by the software or hardware stored in the computer memory and executed by the proper code execution system. For example, if the plurality of procedures or methods is to be implemented by the hardware, like in another embodiment of the present invention, any one of the following known technologies or the combination thereof may be used, such as discrete logic circuits having logic gates for implementing various logic functions upon an application of one or more data signals, application specific integrated circuits having appropriate logic gates, programmable gate arrays (PGA), field programmable gate arrays (FPGA).

It may be understood by those having the ordinary skills in the related art that all or part of the steps in the method of the above embodiments may be implemented by instructing related hardware via programs, the program may be stored in a computer readable storage medium, and the program includes one step or combinations of the steps of the method when the program is executed.

In addition, each functional unit in the present disclosure may be integrated in one progressing module, or each functional unit exists as an independent unit, or two or more functional units may be integrated in one module. The integrated module may be embodied in hardware, or software. If the integrated module is embodied in software and sold or used as an independent product, it may be stored in the computer readable storage medium.

The computer readable storage medium may be, but is not limited to, read-only memories, magnetic disks, or optical disks.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics maybe combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications may be made in the embodiments without departing from spirit, principles and scope of the present disclosure.

What is claimed is:

1. A music note indicating method for an electronic piano, the electronic piano comprising a keyboard with a plurality of keys, a controlling device and a plurality of LED indicating lamps corresponding to the plurality of keys respectively, the plurality of LED indicating lamps being located in a plane parallel to the keyboard, wherein the method comprises:
obtaining a music score information of a predetermined music score by a mobile terminal;
analyzing the music score information to generate a music note sequence comprising at least one first music note data by the mobile terminal;
generating a control signal according to the at least one first music note data and sending the control signal to the controlling device by the mobile terminal; and
controlling the plurality of LED indicating lamps to indicate the music note sequence according to the control signal by the controlling device.

2. The method according to claim 1, wherein controlling the plurality of LED indicating lamps to indicate the music note sequence according to the control signal by the controlling device comprises:
obtaining a second music note data by the mobile terminal; and
detecting whether the second music note data is consistent with the first music note data by the mobile terminal, in which
if not, the controlling device controls the LED indicating lamp which is adapted to indicate a music note comprising the first music note data to keep lighting on, and the mobile terminal stops obtaining a next first music note data, and
if yes, the controlling device controls the LED indicating lamp which is adapted to indicate a music note comprising the first music note data to turn off, the mobile terminal generates a music note comprising a next first music note data and generates a next control signal according to the next first music note data, and the controlling device controls the LED indicating lamp which is adapted to indicate a music note comprising the next first music note data to light on according to the next control signal.

3. The method according to claim 2, wherein the electronic piano further comprises a receiving device, a generating device and a sending device, and obtaining a second music note data by the mobile terminal comprises:
obtaining an input music note information by the receiving device;
generating the second music note data according to the input music note information by the generating device; and
sending the second music note data to the mobile terminal by the sending device.

4. The method according to claim 3, wherein the music score information is a video file comprising a control script, and the method further comprises:
obtaining the control script of the video file and controlling the video file according to the second music note data and the control script by the mobile terminal.

5. The method according to claim 1, further comprising:
recording by the mobile terminal a music played on the electronic piano.

6. The method according to claim 5, further comprising:
obtaining information of the music, and
evaluating the information of the music according to the predetermined music score.

7. A mobile terminal, comprising:
a first obtaining module, configured to obtain a music score information of a predetermined music score;
a first generating module, configured to analyze the music score information to generate a music note sequence comprising at least one first music note data;
a second generating module, configured to generate a control signal according to the at least one first music note data; and
a sending module, configured to send the control signal to an electronic piano comprising a plurality of LED indicating lamps, such that the plurality of LED indicating lamps are controlled to indicate the music note sequence according to the control signal.

8. The mobile terminal according to claim 7, further comprising:
a second obtaining module, configured to obtain a second music note data;
a detecting module, configured to detect whether the second music note data is consistent with the first music note data, in which
if the detecting module determines that the second music note data is inconsistent with the first music note data, the first obtaining module is configured to stop obtaining a next first music note data, and
if the detecting module determines that the second music note data is consistent with the first music note data, the first generating module is configured to generate a music note comprising a next first music data and the second generating module is configured to generate a next control signal according to the next first music note data.

9. The mobile terminal according to claim 8, further comprising:
a controlling module, configured to obtain a control script of a video file and control the video file according to the second music note data and the control script.

10. The mobile terminal according to claim 7, further comprising:
a recording module, configured to record a music played on the electronic piano.

11. The mobile terminal according to claim 10, further comprises:
an evaluating module, configured to obtain information of the music and evaluate the information of the music according to the predetermined music score.

12. An electronic piano, comprising:
a keyboard with a plurality of keys;
a plurality of LED indicating lamps corresponding to the plurality of keys respectively and located in a plane parallel to the keyboard; and
a controlling device, configured to receive a control signal from a mobile terminal, wherein the mobile terminal comprises:
a first obtaining module, configured to obtain a music score information of a predetermined music score;
a first generating module, configured to analyze the music score information to generate a music note sequence comprising at least one first music note data;
a second generating module, configured to generate a control signal according to the at least one first music note data; and
a sending module, configured to send the control signal to an electronic piano comprising a plurality of LED indicating lamps, such that the plurality of LED indicating lamps are controlled to indicate the music note sequence according to the control signal, and
wherein the first obtaining module is further configured to control the plurality of LED indicating lamps to indicate the music note sequence according to the control signal.

13. The electronic piano according to claim 12, wherein the mobile terminal further comprises:
a second obtaining module, configured to obtain a second music note data;
a detecting module, configured to detect whether the second music note data is consistent with the first music note data, in which
if the detecting module determines that the second music note data is inconsistent with the first music note data, the first obtaining module is configured to stop obtaining a next first music note data, and
if the detecting module determines that the second music note data is consistent with the first music note data, the first generating module is configured to generate a music note comprising a next first music data and the second generating module is configured to generate a next control signal according to the next first music note data.

14. The electronic piano according to claim 13, wherein the mobile terminal further comprises:
a controlling module, configured to obtain a control script of a video file and control the video file according to the second music note data and the control script.

15. The electronic piano according to claim 12, wherein the mobile terminal further comprises:
a recording module, configured to record a music played on the electronic piano.

16. The electronic piano according to claim 15, wherein the mobile terminal further comprises:
an evaluating module, configured to obtain information of the music and evaluate the information of the music according to the predetermined music score.

17. The electronic piano according to claim 12, further comprising:
a receiving device, configured to receive an input music note information;
a generating device, configured to generate a second music note data according to the input music note information; and
a sending device, configured to send the second music note data to the mobile terminal.

18. The electronic piano according to claim 17, wherein
when the mobile terminal determines the second music note data is inconsistent with the first music note data, the controlling device is further configured to control the LED indicating lamp which is adapted to indicate a music note comprising the first music note data to keep lighting on; and
when the mobile terminal determines the second music note data is consistent with the first music note data, the controlling device is further configured to control the LED indicating lamp which is adapted to indicate a music note comprising the first music note data to turn off, and to control the LED indicating lamp which is adapted to indicate a music note comprising a next first music note data to light on.

19. A music note indicating system for an electronic piano, comprising a mobile terminal and an electronic piano,
wherein the mobile terminal comprises:
a first obtaining module, configured to obtain a music score information of a predetermined music score;
a first generating module, configured to analyze the music score information to generate a music note sequence comprising at least one first music note data;
a second generating module, configured to generate a control signal according to the at least one first music note data; and
a sending module, configured to send the control signal to an electronic piano comprising a plurality of LED indicating lamps, such that the plurality of LED indicating lamps are controlled to indicate the music note sequence according to the control signal, and
wherein the electronic piano comprises
a keyboard with a plurality of keys;
a plurality of LED indicating lamps corresponding to the plurality of keys respectively and located in a plane parallel to the keyboard; and
a controlling device, configured to receive a control signal from the mobile terminal, and to control the plurality of LED indicating lamps to indicate the music note sequence according to the control signal.
